(19) United States
(12) Patent Application Publication
(10) Pub. No.: US 2023/0137559 A1
(43) Pub. Date: May 4, 2023

(54) INTERFACE SUPPORT FOR BICYCLE SHOE WITH CLEAT

(71) Applicant: Sean Christopher Gayle, Portland, ME (US)

(72) Inventor: Sean Christopher Gayle, Portland, ME (US)

(21) Appl. No.: 18/087,693

(22) Filed: Dec. 22, 2022

Related U.S. Application Data
(63) Continuation-in-part of application No. 17/378,058, filed on Jul. 16, 2021.
(60) Provisional application No. 63/142,585, filed on Jan. 28, 2021.

(51) Int. Cl. A43C 15/16; A43B 5/14; B62M 3/08

(52) U.S. Cl. CPC A43C 15/161; A43B 5/14; B62M 3/086

(57) ABSTRACT

A support interface apparatus removably couplable to a cleated cycling shoe to enable the user to walk on an underlying substrate with minimal slipping on the substrate and/or minimal damage to the underlying substrate by the cleat. The apparatus includes a base pad and a cleat cavity located in the front portion of the base pad. The cleat cavity includes a perimeter, a base, and a cleat-retaining space established by the perimeter and the base. The base pad of a first embodiment is formed of two layers of material and a second embodiment is formed of three layers of EVA material. The cleat cavity is arranged for removably retaining the cleat of the cycling shoe therein so that the user may walk on the underlying surface without the heel and the cleat making direct contact with the underlying substrate.

### BACKGROUND OF THE INVENTION

### 1. Field of the Invention

The present invention relates to adaptive apparatuses for use with bicycle shoes. More specifically, the present invention relates to such apparatuses for those bicycle shoes including cleats for riding bicycles with clipless pedals. Still more specifically, the present invention relates to an apparatus configured to enable walking with cleated bicycle shoes while minimizing slippage between the shoes and the underlying walking surface.

### 2. Description of the Prior Art

Cleated bicycle shoes are used by riders to engage with the pedals of clipless pedal bicycles. Clipless pedals are desirable for various reasons but requires the use of cleated bicycle shoes to secure engagement of the shoes with the pedals. While cleated bicycle shoes are useful while riding, there are disadvantages once the rider disembarks from the bicycle and wishes to walk without removing the shoes. Specifically, such cleated cycling shoes are not stable footwear to walk around in when not clipped into pedals on a bicycle. The cleats are made of a hard nonmetallic material such as a plastic including, but not limited to Nylon. They are particularly slippery on hard surfaces but also are a challenge on other surfaces. They can also cause damage to the underlying surface.

In addition to the slipperiness and damage-inducing features of the cleats, there is a further disadvantage when walking in cleated cycling shoes. The cleats are only located on the forward section of the sole of the shoe. There are no cleats on the heel section or the section between the forward and heel sections. As a result, the wearer must deal with a “negative” heel stance (the heel section is below the level of the forward section) that gives the feel of constantly walking uphill.

While cleated bicycle shoes are desirable when riding bicycles with clipless pedals, they cause difficulties when the wearer wish to walk in them. Those difficulties include the slipperiness and unevenness described. A known existing attempt to overcome the slipping problem is a cleat cover that only covers the cleat with a rubberized cover but does not solve for the negative heel or walking stability issues. What is needed is an apparatus that the wearer can easily transition into for walking and then transition out of when riding the bicycle. What is also needed is such an apparatus that substantially eliminates slipping, surface damage, and unevenness when the wearer is walking.

### SUMMARY OF THE INVENTION

It is an object of the present invention to provide an apparatus that the wearer of cleated bicycle shoes can easily use to transition into for walking and then transition out of when riding the bicycle. It is also an object of the invention to provide such an apparatus that substantially eliminates slipping, surface damage, and unevenness when the wearer is walking.

These and other objects are achieved with the present invention, which is an interface support apparatus that is easily coupled to and decoupled from a cleated cycling shoe. The apparatus provides a stable, even surface that eliminates the negative heel stance that accompanies walking in cycling shoes by providing a flat surface on which to stand and walk. The apparatus is simple and functional. It allows the user to keep cleated cycling shoes on while walking comfortably on an underlying surface.

The apparatus includes a base pad having a front section, a heel section, and an intermediate section between the front section and the heel section. The base pad includes a top surface and a bottom surface. A cavity is formed in the top surface of the front section. The cavity is configured to removably retain therein the cleat of a cleated cycling shoe. The cavity provides a frictional fit between that portion of the base pad and the cleat so that when the wearer walks while still in the cycling shoes, the apparatus encases the cleat so that it moves with the wearer. At least a portion of the bottom surface of the base pad is made of a material that can provide grip to an underlying surface. It may also include some form of texturing to enhance or provide that grip. The cavity in the top surface of the forward section is made sufficiently deep to retain most or all of the cleat therein so that the sole of the cycling shoe is substantially flat relative to the top surface of the base pad through all sections of the base pad. That configuration substantially eliminates the negative heel stance.

The cavity of the base pad allows the wearer to clip into the apparatus for an easy transition in, and to pull the cleat out of the cavity for an easy transition out, both without removing the cycling shoes from the feet. After stepping into the apparatus, the wearer can walk on floors without scratching or damaging them. It also minimizes slipping. The apparatus is made of a lightweight material such as a nonmetallic including viscoelastic material that is relatively softer than a hard plastic. The “clip in” cavity allows use of Standard cycling cleats.

The apparatus may be used indoors or outside. The base pad may be made of a single material with the cavity molded therein or later cut from the formed pad. The base pad may also be formed of two or more layers. For example, in a first embodiment, there may be a top layer and a bottom layer. The top layer may be formed of a relatively rigid material such as a thermoplastic urethane (TPU). The top layer may be molded around the cleat cavity. It is simultaneously rigid and flexible enough to allow just enough give for a standard road cycling shoe cleat to “clip in” and be held in by friction fit. The bottom layer may be formed of the same or a different material such as an ethyl vinyl acetate (EVA) selected to allow for shock absorption, low-slippage, and comfort while walking. In a second embodiment of the invention, the base pad is made of three layers, wherein each layer is formed of EVA material. These materials are of relatively low weight. The base pad may be sufficiently flexible to allow storage in a pocket of a cycling jersey or another compartment while riding. Since the cycling shoe cleat sits within the apparatus cavity, it eliminates negative heel instability allowing a similar walking experience as being in a pair of sandals.

These and other advantages of the apparatus of the present invention are further considered in the following detailed description, accompanying drawings and appended claims.

### BRIEF DESCRIPTION OF THE DRAWINGS

FIG. 1 is a top view of a first embodiment of the interface support apparatus of the present invention.

FIG. 2 is a side view of the apparatus of FIG. 1.

FIG. 3 is a cross sectional side view of the apparatus of FIG. 1 showing the cleat cavity.

FIG. 4 is a top view of the front section of the apparatus of FIG. 1 showing the cleat cavity.

FIG. 5 is a bottom view of the front section of the apparatus of FIG. 1 showing the cleat cavity in phantom.

FIG. 6 is a side view of the cleat cavity of FIG. 1.

FIG. 7 is a cross sectional side view of the cleat cavity of FIG. 1.

FIG. 8 is a is a top view of a second embodiment of the interface support apparatus of the present invention.

FIG. 9 is a side view of the apparatus of FIG. 8.

FIG. 10 is a cross sectional side view of the apparatus of FIG. 8 showing the cleat cavity.

FIG. 11 is a top view of the front section of the apparatus of FIG. 8 showing the cleat cavity.

FIG. 12 is a bottom view of the front section of the apparatus of FIG. 8 showing the cleat cavity in phantom.

FIG. 13 is a cross sectional side view of the cleat cavity of FIG. 8.

FIG. 14 is a representation of the lower portion of a cyclist transitioning into the apparatus of the present invention.

FIG. 15 is a representation of the cyclist walking while in the apparatus of the present invention.

FIG. 16 is a representation of the cyclist about to remove a cleated cycling shoe from the apparatus.

FIG. 17 is a representation of the cyclist with both cleated cycling shoes removed.

### DETAILED DESCRIPTION OF THE INVENTION

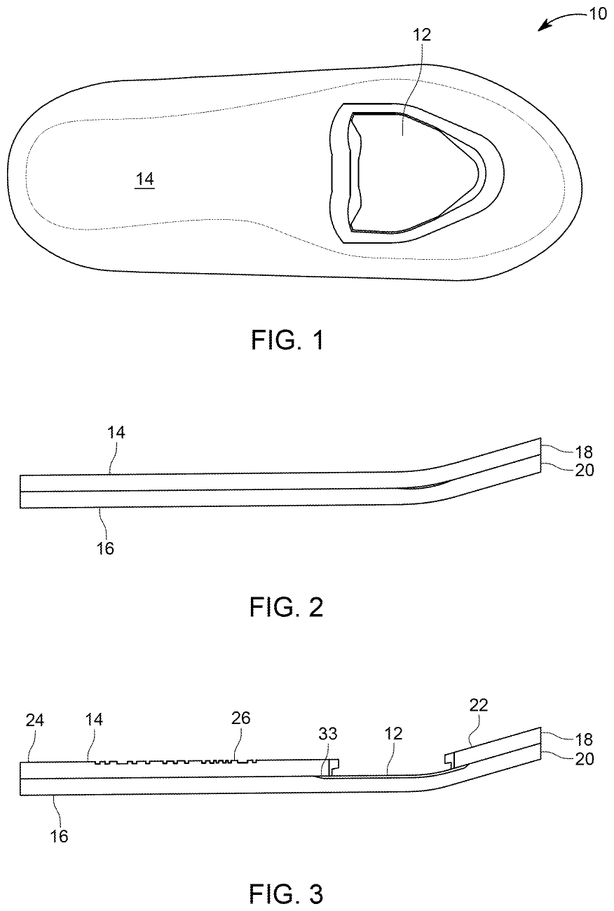

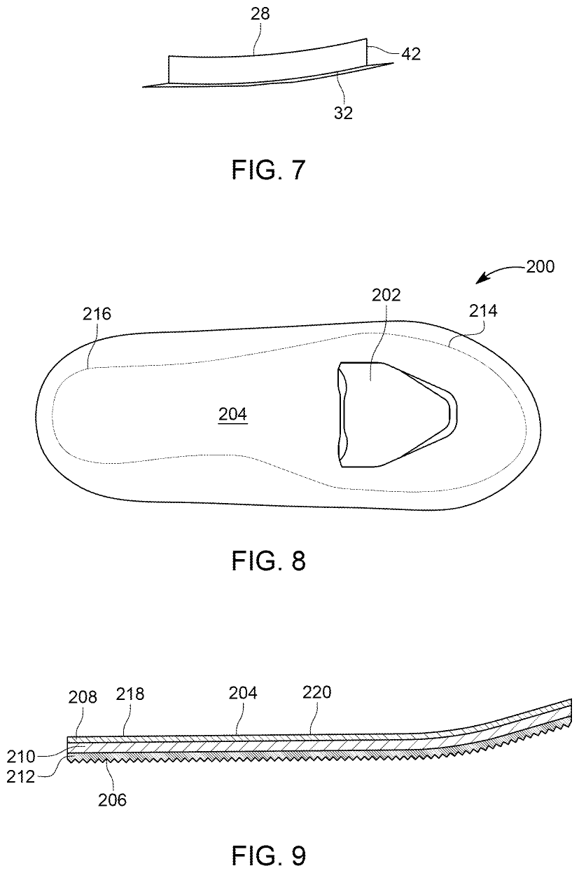

A first embodiment of an interface support apparatus 10 of the present invention is shown in FIGS. 1-7. The apparatus 10 functions as a cushion and interface between a cleated cycling shoe 100 and an underlying substrate 102 (shown in FIGS. 14-17). The apparatus 10 enables the user to removably insert a shoe cleat 104 into a cleat cavity 12 extending into a top surface 14 of the apparatus 10 and to retain the cleat 104 in the cavity 12 until intentionally removing it.

The apparatus 10 includes a bottom surface 16 arranged to make contact with the underlying substrate 102. The bottom surface 16 may be smooth, textured or shaped as desired provided the material comprising the bottom surface 16 is sufficiently frictional to minimize sliding of the apparatus 10 plus shoe 100 on the substrate 102. The apparatus 10 may be of variable dimensions, provided it has a width and a length approximately corresponding to the width and length of the shoe 100, although they do not have to be precisely the same. The cleat cavity 12 is formed with dimensions sufficient to securely retain the cleat 104 therein.

The apparatus 10 may be formed as a unitary piece or it may be formed in at least two layers as shown in FIGS. 2 and 3. The layers include a top layer 18 and a bottom layer 20. The top layer 18 may be formed of a relatively rigid material such as a thermoplastic urethane (TPU) but not limited thereto. The top layer 18 is simultaneously rigid and flexible enough to allow just enough give for a standard road cycling shoe cleat to “clip in” and be held in by friction fit. The bottom layer 20 may be formed of the same or a different material such as an ethyl vinyl acetate (EVA), but not limited thereto, selected to allow for shock absorption, low-slippage, and comfort while walking.

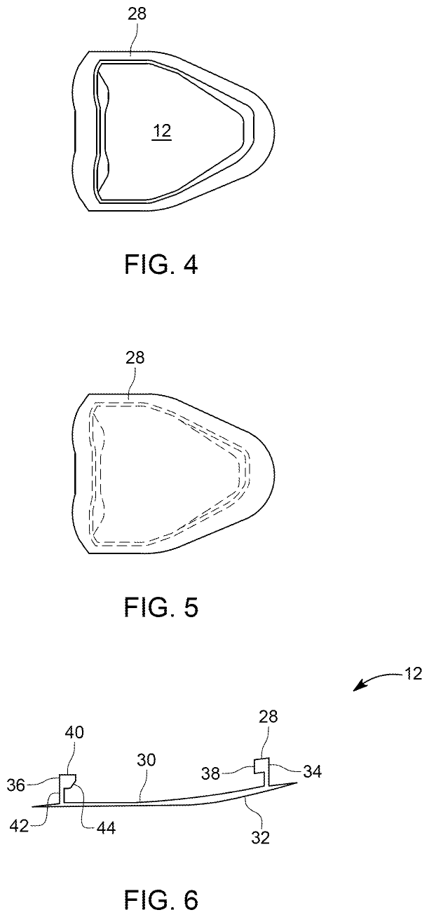

The top layer 18 includes the cleat cavity 12 therein. The cleat cavity 12 is located in a front portion 22 of the apparatus. The front portion 22 is spaced from a heel portion 24 by an intermediate portion 26. As shown in FIGS. 4-7, the cleat cavity 12 includes a perimeter 28, a cleat-retaining space 30, and a base 32. The base 32 may extend into interface 33 between the top layer 18 and the bottom layer 20 of the apparatus.

The perimeter 28 and space 30 of the cleat cavity 12 are shown in the form of a rounded triangle in FIGS. 4 and 5 but is not limited to that specific configuration. However, the rounded triangle configuration ensures that the cleat 104 is completed positioned in the cavity 12 while also being removably retained therein. A cleat cavity that has a inched front end limit the ability to place the entire cleat 104 in the cavity 12 so that the entire cleat can be retained. The perimeter 28 includes a forward clip 34 and a rear clip 36. The clips 34 and 36 are arranged for securing the cleat 104 in the space 30 resting on the base 32. The clips 34 and 36 are rigid enough to keep the shoe 100 on the apparatus 10 when together, but also flexible enough to permit the user to withdraw the cleat 104 from the cavity 12. The forward clip 34 includes a forward lip section 38, and the rear clip 36 includes a rear lip section 40, both of which extend inwardly from cavity ring 42. The lip sections 38 and 40 aid in the securing of the cleat 12 in the space 30. Optionally, a portion 44 of the rear lip section 40 may be rounded to facilitate cleat release from the apparatus 10.

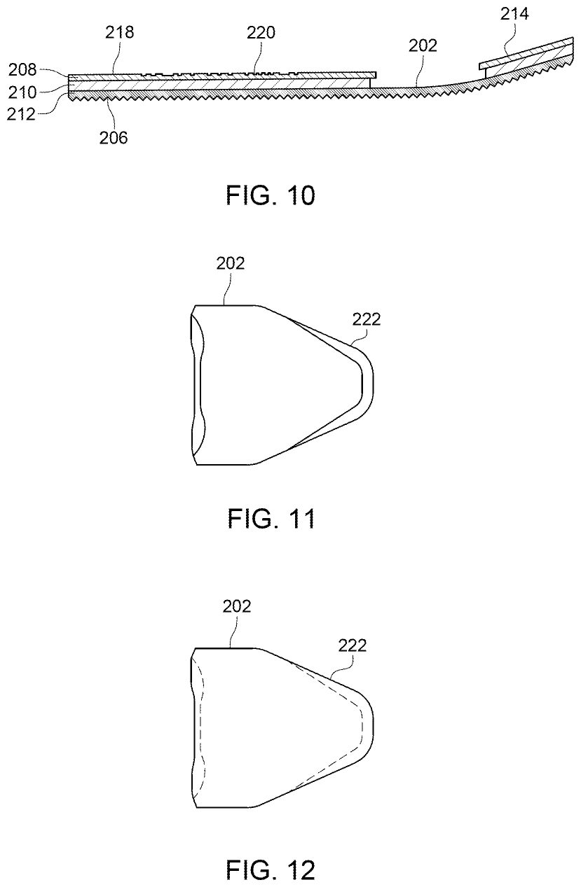

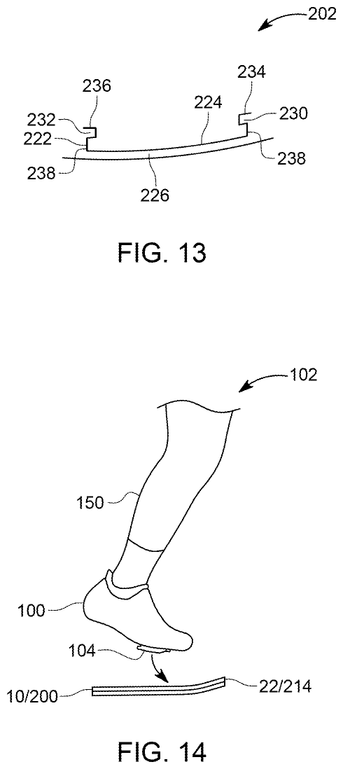

A second embodiment of an interface support apparatus 200 of the present invention is shown in FIGS. 8-13. The apparatus 200 functions as a cushion and interface between the cleated cycling shoe 100 and the underlying substrate 102 shown in FIGS. 14-17. The apparatus 200 enables the user to removably insert a shoe cleat 104 into a cleat cavity 202 extending into a top surface 204 of the apparatus 200 and to retain the cleat 104 in the cavity 202 until intentionally removing it.

The apparatus 200 includes a bottom surface 206 arranged to make contact with the underlying substrate 102. The bottom surface 206 is arranged with a gripping configuration, such as with a texture, serration, or other form of surface profile that facilitates gripping of the substrate 102. The bottom surface 206 may have a herringbone construction. The bottom surface 206 may alternatively be smooth provided the material comprising the bottom surface 206 is sufficiently frictional to minimize sliding of the apparatus 200 plus shoe 100 on the substrate 102. The apparatus 200 may be of variable dimensions, provided it has a width and a length approximately corresponding to the width and length of the shoe 100, although they do not have to be precisely the same. The cleat cavity 202 is formed with dimensions sufficient to securely retain the cleat 104 therein.

The apparatus 200 is formed of three layers of relatively pliable material. The layers include a top layer 208, a middle layer 210, and a bottom layer 212. The top layer 208, the middle layer 210, and the bottom layer 212 are each made of EVA. The layer materials are selected to enable a standard cycling shoe cleat to “clip in” and be held in by friction fit, and to allow for shock absorption, low-slippage, and comfort while walking.

The top layer 208 includes the cleat cavity 202 therein. The cleat cavity 202 is located in a front portion 214 of the apparatus. The front portion 214 is spaced from a heel portion 218 by an intermediate portion 220. As shown in FIGS. 11-13, the cleat cavity 202 includes a perimeter 222, a cleat-retaining space 224, and a base 226. The base 226 may extend into interface 228 between the top layer 208 and the middle layer 210 of the apparatus 200.

The perimeter 222 and the space 224 of the cleat cavity 202 are shown in the form of a rounded triangle but is not limited to that specific configuration. However, the rounded triangle configuration ensures that the cleat 104 is completed positioned in the cavity 12 while also being removably retained therein. A cleat cavity that has a inched front end limit the ability to place the entire cleat 104 in the cavity 12 so that the entire cleat can be retained. The perimeter 222 includes a forward clip 230 and a rear clip 232. The clips 230 and 232 are arranged for securing the cleat 104 in the space 224 resting on the base 226. The clips 230 and 232 are rigid enough to keep the shoe 100 on the apparatus 200 when together, but also flexible enough to permit the user to withdraw the cleat 104 from the cavity 202. The forward clip 230 includes a forward lip section 234, and the rear clip 232 includes a rear lip section 236, both of which extend inwardly from cavity ring 238. The lip sections 234 and 236 aid in the securing of the cleat 104 in the space 224. Optionally, a portion 238 of the rear lip section 236 may be rounded to facilitate cleat release from the apparatus 200.

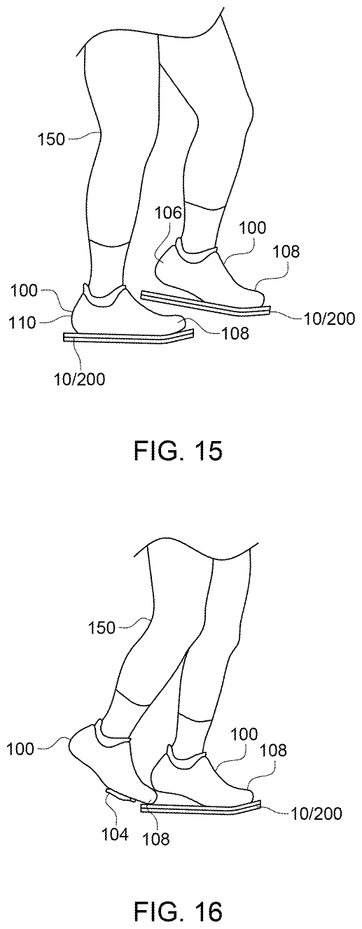

Use of the apparatus 10 or the apparatus 200 to enable a user to keep the cleated cycling shoe on while walking on a surface is represented in FIGS. 14-17. In FIG. 14, a user 150 directs the shoe 100 toward the front portion 22/214 of the apparatus 10/200, aligning the cleat 104 with the cleat cavity 12/202. FIG. 15 shows two of the shoes 100 retained to two of the apparatuses 10/200, with the cleat 104 removably retained at the front portion 22/214 of the apparatuses 10/200. FIG. 14 further shows the user 150 moving forward with heel 106 of the shoe 100 to the right up spaced from the heel portion 24/218 with toe section 108 secured to the apparatus 10/200 at the front portion 22/214 to provide a normal walking method. The shoe 100 to the left is shown with the heel 110 down on the heel portion 24/218 and the toe section 108 secured to the front portion 22/214, illustrating resolution of the negative heel stance.

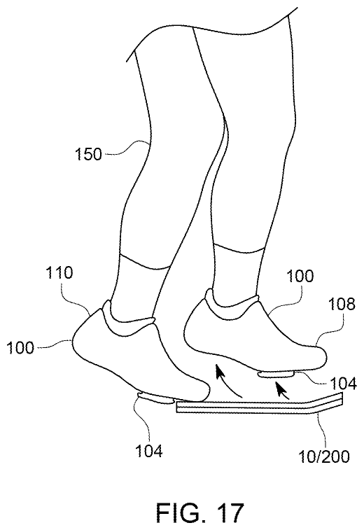

FIG. 16 shows the user 150 initiating disengagement of the shoe 100 from the apparatus 10/200. Specifically, the user 150 uses the toe section 108 of the shoe 100 to the left to keep the apparatus 10/200 on the underlying substrate 102 before pulling the cleat 104 from the cleat cavity 12/202. FIG. 17 illustrates the outcome of the disengagement effort, with the shoe 100 to the right spaced away from the apparatus 10/200 and the cleat 104 free from the cavity 12/202.

The cavity 12/202 is arranged for removably retaining the cleat 104 of the cycling shoe 100 therein so that the user 150 may walk on the underlying substrate 102 without the heel 106 and the cleat 104 making direct contact with the underlying substrate 102.

The present invention has been described with respect to specific examples of its embodiment. It is not intended to be limited to those specific examples but is instead described by the following claims and equivalents.

What is claimed is:

1. An apparatus configured to function as a support interface between a cycling shoe having a heel and a cleat and an underlying substrate to enable walking on the substrate with the cycling shoe on, the apparatus comprising:
a base pad having a top surface, a bottom surface, a front portion, and a heel portion; and
a cleat cavity located in the front portion and the top surface only of the base pad, the cleat cavity including a perimeter, a base, and a cleat-retaining space established by the perimeter and the base, wherein the cleat cavity is of a rounded triangle configuration.

2. The apparatus of claim 1, wherein the base pad is formed of a top layer and a bottom layer, and wherein the cleat cavity is located in the top layer of the base pad.

3. The apparatus of claim 2, wherein the top layer is fabricated of thermoplastic urethane and the bottom layer is fabricated of ethyl vinyl acetate.

4. The apparatus of claim 1, wherein the bottom surface of the base pad is formed of a material selected to enhance grip between the apparatus and the underlying substrate.

5. The apparatus of claim 1, wherein the perimeter of the cleat cavity includes a forward clip and a rear clip for removably securing the cleat of the cycling shoe in the space of the cavity.

6. The apparatus of claim 5, wherein each of the forward clip and the rear clip is formed of a perimeter ring and a lip extending inwardly into the space from the perimeter ring.

7. The apparatus of claim 6, wherein the lip of the rear clip is rounded to facilitate removal of the cleat from the cleat cavity.

8. An apparatus configured to function as a support interface between a cycling shoe having a heel and a cleat and an underlying substrate to enable walking on the substrate with the cycling shoe on, the apparatus comprising:
a base pad having a top surface, a bottom surface, a front portion, and a heel portion, a top layer, a middle layer, and a bottom layer; and
a cleat cavity located in the front portion and only in the top layer and middle layer of the base pad, the cleat cavity including a perimeter, a base, and a cleat-retaining space established by the perimeter and the base, wherein the cleat cavity is of a rounded triangle configuration.

9. The apparatus of claim 8, wherein the top layer, the middle layer, and the bottom layer are all fabricated of ethyl vinyl acetate.

10. The apparatus of claim 8, wherein the bottom surface of the base pad is formed with a herringbone configuration.

11. The apparatus of claim 8, wherein the perimeter of the cleat cavity includes a forward clip and a rear clip for removably securing the cleat of the cycling shoe in the space of the cavity.

12. The apparatus of claim 11, wherein each of the forward clip and the rear clip is formed of a perimeter ring and a lip extending inwardly into the space from the perimeter ring.

13. The apparatus of claim 6, wherein the lip of the rear clip is rounded to facilitate removal of the cleat from the cleat cavity.
